(19) United States
(12) Patent Application Publication
(10) Pub. No.: US 2014/0003904 A1
(43) Pub. Date: Jan. 2, 2014

(54) METHOD OF USING SLIP SHEETS EXHIBITING COMPRESSIBILIY PROPERTIES FOR THE PURPOSE OF IMPROVING PULSATING GRAVITY CONVEYOR SYSTEMS

(71) Applicant: John F. Wylie, Belle Isle, FL (US)

(72) Inventor: John F. Wylie, Belle Isle, FL (US)

(21) Appl. No.: 13/922,042

(22) Filed: Jun. 19, 2013

Related U.S. Application Data
(60) Provisional application No. 61/666,326, filed on Jun. 29, 2012.

(51) Int. Cl. B65G 57/00

(52) U.S. Cl. CPC B65G 57/005
USPC 414/802

(57) ABSTRACT

A new and useful method of using slip sheets comprising materials that exhibit compressibility properties for the purpose of improving load guidance and alignment. Because of the new and useful features of the present invention, the conveyance of palletized loads will exhibit improved guidance of the load as the slip sheet compresses while in use, provide a cheaper and optionally reusable, disposable or recyclable alternative than pallets in the current art. A method according to the present invention is believed to provide increased guidance of the load as the slip sheet compresses while in use, and an alternative to pallets which are cheaper, disposable and recyclable.

### CROSS-REFERENCE TO RELATED APPLICATIONS

This Application claims the benefit of U.S. Provisional Application No. 61/666,326, filing date Jun. 29, 2012 which is hereby incorporated in its entirety by reference.

### TECHNICAL FIELD

This invention relates generally to pulsating gravity conveyors. More specifically this invention relates to a method of using slip sheets comprising materials that exhibit compressibility properties for the purpose of improving load guidance and alignment.

### BACKGROUND OF THE INVENTION

In the current art loads of materials or goods are palletized and moved along conveyors. This system is ubiquitous in industries where transport of unit loads is required. Generally a pallet is a flat transport structure which provides stability and supports unit loads while being lifted by a forklift or other jacking device. It is also common in industries where unit loads are transported in containers to a destination. Pallets are usually wooden, but can also made of plastic or other. Each material in the current art is selected for varying properties and purposes. The term “palletized” has come to mean the mounting of the desired articles, or load, atop a wooden pallet. Optionally, the articles are fixed to the pallet by a fastening means such as shrink wrap or straps. The wooden pallet is rigid, relatively expensive, and prone to breakage after repeated use. Also, current pallets are not eco-friendly. It is estimated that in the US 200 million trees are cut down for pallet construction each year. An estimated 2 billion pallets are in use each day in the US.

A pulsating gravity conveyor is disclosed within U.S. Pat. No. 4,205,740, entitled “PULSATING GRAVITY CONVEYOR WITH LOAD ALIGNMENT MEANS.” The disclosure is hereby incorporated by reference.

U.S. Pat. No. 4,205,740 discloses a gravity-type roller conveyor which has a plurality of rollers mounted on an interior elongated support member that is moveably positioned within an exterior elongated frame member. Underneath the interior elongated support member, and within a channel created by the surrounding exterior support member, lies a pneumatic hose controlled by an external controlling device. When inflated, the hose causes the interior support member to rise above a surface known as the braking surface. This braking surface is simply a resting area for which the load being conveyed above to rest upon. When raised above the braking surface, the load rolls along the plurality of rollers as dictated by gravitational force. To cease movement, the hose is deflated, the interior support member subsides, and the load comes to rest once again on the braking surface. The cyclical raising and lowering of the rollers permit the intermittent controlled movement of articles, specifically palletized loads along a conveyor. It is common that loads shift or become misaligned while moving along conveyors. Alate structures have been implemented on some conveyors used in the current art to assist in correction alignment. However the use of these structures is inconsistent, not reliably successful when implemented, and requires alteration to existing conveyors if added.

In the applicant's experience there is a deficiency in the existing and prior art wherein there is no new and useful method that allows for improved alignment, guidance and stability of a palletized load. The present invention provides a new and useful method that incorporates the use of a slip sheet instead of, or in concert with existing pallets, to improve guidance in use and provide a cheaper and more flexible option than existing rigid, wood pallets. The advantages of this invention over the existing art include: i) increasing guidance of the load as the slip sheet compresses while in use, ii) providing a cheaper alternative than pallets for conveying purposes, iii) providing a disposable alternative to pallets, and iv) creating a recyclable and sustainable alternative to existing pallets. The method of the present invention is believed to accomplish all of the foregoing objectives.

### SUMMARY OF THE INVENTION

The present invention provides a new and useful method of using slip sheets comprising materials that exhibit compressibility properties for the purpose of improving load guidance and alignment. Because of the new and useful features of the present invention, the conveyance of palletized loads will exhibit improved guidance of the load as the slip sheet compresses while in use, provide a cheaper and optionally reusable, disposable or recyclable alternative than pallets in the current art.

The present invention achieves the result of improved guidance and traction by implementing a slip sheet made of materials exhibiting compressibility properties. In thermodynamics and fluid mechanics, compressibility is a measure of the relative volume change of a fluid or solid as a response to a pressure (or mean stress) change. In the present invention the system of the slip sheet, load and conveyor working in concert in a cyclical raising and lowering motion exposes the slip sheet to compression forces along compression zones between the load and conveyor braking surfaces. This repeated compression deforms the slip sheet to create channels or grooves along the slip sheet. These grooves act to track or guide the load to travel parallel to the conveyor while in motion. These grooves also increase grip of the load to the conveyor and increase control and minimize slipping that is common in the current art.

The present invention also achieves the result of providing a cheaper, disposable, and recyclable alternative to existing pallets by implementing alternative materials. Currently, pallets are rigid and made of wood. These materials require the harvesting of millions of trees and extensive labor to produce—thereby increasing the cost to the end user. The present invention will replace that paradigm by creating slip sheets out of cheap particulate or corrugate materials such as cardboard, foam core or an equivalent. The materials used in the present invention are also more easily disposed, replaced and recycled than the current art.

The method of using slip sheets exhibiting compressibility properties for the purpose of improving pulsating gravity conveyor systems comprises the steps of selecting a slip sheet made from a material exhibiting compressibility properties such as cardboard, corrugate, foam core, rubber, or an equivalent. Once selected, the operator places the slip sheet atop a gravity type roller conveyor. A load is then placed on top of the slip sheet. The contents of the load can be any article desired to be conveyed, for example building supplies or articles of manufacture. The operator then cyclically raises and lowers the rollers of the conveyor to permit the intermittent controlled movement of the load along the conveyor route. The cyclical raising and lowering of the load exposes the slip sheet to compression between the load and the braking surfaces of the conveyor. Over time, the compression forces create deformations in the slip sheet akin to tracks or channels. These tracks or channels aid in guidance, traction and control of the load while in transit to a destination. Finally, the operator removes the load from the conveyor upon arrival to a desired location.

At the operator's discretion, the slip sheet may be reused, replaced, recycled or disposed of as needed.

In one of its basic embodiments, the present invention achieves this result by creating a new and useful method of using slip sheets comprising materials that exhibit compressibility properties for the purpose of improving load guidance and alignment.

The method of the present invention comprises the steps of first selecting a slip sheet. The slip sheet is made from a material exhibiting compressibility properties, such as cardboard, corrugate, foam core, or an equivalent.

In the next step the slip sheet is placed atop a gravity type roller conveyor. These conveyors are already commonly found in the environment of the current art—namely warehouses and packaging and shipping centers.

Next a load is placed atop the slip sheet. The load is any shipment or article desired to be conveyed, for example building supplies or articles of manufacture.

The load which is now situated atop the slip sheet is cyclically raised and lowered by a conveyor operator along the rollers. This cyclical action acting in concert with gravity permit the intermittent controlled movement of articles along the conveyor. While the load is cyclically raised and lowered, compression forces are exhibited upon the slip sheet in compression zones along the points of contact with conveyor braking surface. This creates deformations in the slip sheet akin to tracks or channels which aid in guidance, traction and control of the load while in transit to a destination.

Finally the load is removed from the conveyor upon arrival to desired location.

In another embodiment of the present invention the method further comprises a step wherein the operator optionally fixes the load to the slip sheet by a fastening means such as shrink wrap or straps. This step can take place during any point of the method. Usually shrink wrapping a load to a palette occurs prior to moving the load. This acts to impeded shifting or spilling of the load during transit along a conveyor.

In another embodiment of the present invention the operator may append the step of using a pallet above the slip sheet and under the load.

After use, the slip sheet can be optionally reused, recycled, or disposed of.

Thus the present invention provides a new and useful method of using slip sheets comprising materials that exhibit compressibility properties for the purpose of improving load guidance and alignment. The advantages of this invention over the existing art include: i) increasing guidance of the load as the slip sheet compresses while in use, ii) providing a cheaper alternative than pallets for conveying purposes, iii) providing a disposable alternative to pallets, and iv) creating a recyclable and sustainable alternative to existing pallets. The method of the present invention is believed to accomplish all of the foregoing objectives.

Further features and objectives of the present invention will become apparent form the following detailed description and the accompanying drawings.

### BRIEF DESCRIPTION OF THE DRAWINGS

FIG. 1 is a cross section of the present invention with the slip sheet atop the conveyor system. No compression of the slip sheet is shown.

FIG. 2 is a cross section of the present invention with the slip sheet raised while in transit. Compression is shown along the bottom surface of the slip sheet in zones that contact the rollers and braking surfaces of the conveyor.

FIG. 3 is cross section of the present invention with the slip sheet lowered while at rest. Compression is shown along the bottom surface of the slip sheet in zones that contact the braking surfaces of the conveyor.

### DETAILED DESCRIPTION OF THE INVENTION

As described above, the present invention provides a new and useful method of using slip sheets comprising materials that exhibit compressibility properties for the purpose of improving load guidance and alignment.

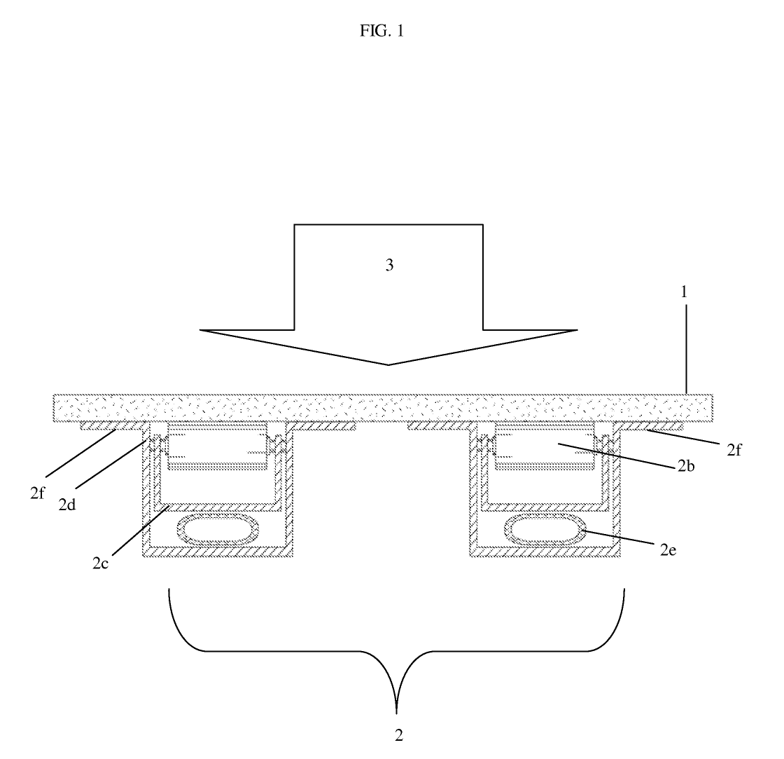

Referring now to the invention in more detail, in FIG. 1 to FIG. 3 the present invention is shown with the slip sheet 1 atop a pulsating gravity conveyor system 2 shown generally. In each of FIG. 1 to FIG. 3, the pulsating gravity conveyor system 2 comprises a plurality of rollers 2b mounted on an interior elongated support member 2c that is moveably positioned within an exterior elongated frame member 2d. A pneumatic hose 2e is held within each channel defined by the surrounding exterior support member 2d and lying underneath the interior elongated support member 2c.

Specifically FIG. 1 shows a cross section of the present invention with the slip sheet 1 atop the conveyor system 2 shown generally. No compression of the slip sheet 1 is shown. A load 3 is shown atop the slip sheet 1 and exerting force downward. The pneumatic hose 2e is shown in a deflated state.

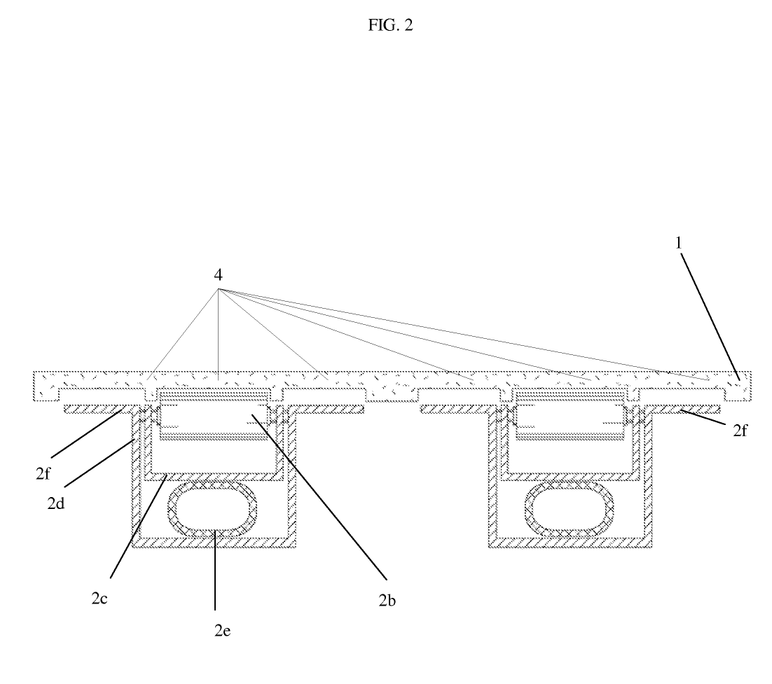

FIG. 2 shows a cross section of the present invention with the slip sheet 1 atop the conveyor system 2 while in operation. The pneumatic hose 2e is shown in the inflated state, thereby raising the interior elongated support member 2c and the attached rollers 2b. The slip sheet 1 is raised and only in contact with the rollers 2e. The slip sheet is not in contact with the braking surfaces 2f along the exterior elongated support member 2d. A plurality of compression zones 4 are shown along the bottom of the slip sheet 1 and above the braking surfaces 2f of the elongated support member 2d.

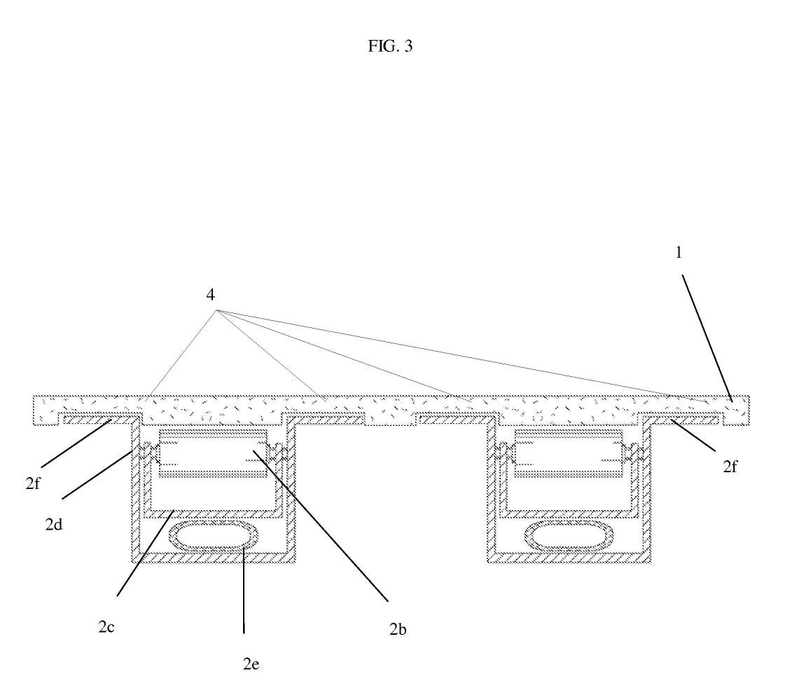

FIG. 3 shows a cross section of the present invention with the slip sheet 1 atop the conveyor system 2 while at rest. The pneumatic hose 2e is shown in the deflated state. The interior elongated support member 2c and the attached rollers 2b are lowered. The slip sheet 1 is in contact and resting on the braking surfaces 2f along the exterior support member 2c. This figure shows the present invention at a resting state or at an interval during the cyclical operation where the slip sheet 1 is lowered.

Referring now to FIG. 1 to FIG. 3 in more detail, the present invention is shown which is a method of using slip sheets 1 exhibiting compressibility properties for the purposes of improving pulsating gravity conveyor systems 2 which comprises the following steps. First the operator selects a slip sheet 1 which is made from a material exhibiting compressibility properties, such as cardboard, corrugate, foam core, or an equivalent. The operator then places the slip sheet 1 atop a gravity type roller conveyor 2 where the roller conveyor 2 has a plurality of rollers 2b mounted on an interior elongated support member 2c that is moveably positioned within a exterior elongated frame member 2d, a pneumatic hose 2e held within a channel defined by the surrounding exterior support member 2d and lying underneath the interior elongated support member 2c, and a plurality of braking surfaces 2f along the conveyor 2.

Next, the operator places a load 3 atop the slip sheet. The load can be any articles desired to be conveyed, for example building supplies or articles of manufacture.

The operator then cyclically raises and lowers the rollers 2b to permit the intermittent controlled movement of articles along the conveyor 2. This cyclical raising and lowering of the load 3 exhibits compression forces upon the slip sheet 1 in compression zones 4 along the points of contact with conveyor braking surface 2f. The compression forces creates deformations in the slip sheet 1 akin to tracks or channels which aid in guidance, traction and control of the load 3 while in transit to a destination.

Finally, the operator removes the load 3 from the conveyor 2 upon arrival to desired location.

In an alternate embodiment, the method further includes a step wherein the operator optionally fixes the load 3 to the slip sheet 1 by a fastening means such as shrink wrap or straps.

In an alternate embodiment, the method further includes a step wherein the operator uses a pallet above the slip sheet 1 and below a load 3.

In an alternate embodiment, the method further includes a step wherein the operator reuses the slip sheet 1 for repeated use.

In an alternate embodiment, the method further includes a step wherein the operator recycles the slip sheet after use.

In an alternate embodiment, the method further includes a step wherein the operator disposes of the slip sheet after use.

The previously described versions of the present invention have many advantages including and without limitation: i) increasing guidance of the load as the slip sheet compresses while in use, ii) providing a cheaper alternative than pallets for conveying purposes, iii) providing a disposable alternative to pallets, and iv) creating a recyclable and sustainable alternative to existing pallets. The method of the present invention is believed to accomplish all of the foregoing objectives. The invention does not require that all the advantageous features and all the advantages need to be incorporated into every embodiment of the invention.

Although the present invention has been described in considerable detail with reference to certain preferred versions thereof, other versions are possible. Therefore the spirit and scope of the appended claims should not be limited to the description of the preferred versions contained therein.

The reader's attention is directed to all papers and documents which are filed concurrently with this specification and which are open to public inspection with this specification, and the contents of all such papers and documents are incorporated herein by reference.

All the features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. As for “means for” elements, the applicant intends to encompass within the language any structure presently existing or developed in the future that performs the same function. The invention should therefore not be limited by the above described embodiment, method, and examples, but by all embodiments and methods within the scope and spirit of the invention.

What is claimed is:

1. A method of using slip sheets exhibiting compressibility properties for the purposes of improving pulsating gravity conveyor systems comprising:
a) selecting a slip sheet,
said slip sheet made from a material exhibiting compressibility properties, such as cardboard, corrugate, foam core, or an equivalent;
b) placing the slip sheet atop a gravity type roller conveyor,
said conveyor having a plurality of rollers mounted on an interior elongated support member that is moveably positioned within a exterior elongated frame member, a pneumatic hose held within a channel defined by the surrounding exterior support member and lying underneath the interior elongated support member, and a plurality of braking surfaces along the conveyor;
c) placing a load atop the slip sheet,
said load can be any articles desired to be conveyed, for example building supplies or articles of manufacture;
d) cyclically raising and lowering the rollers to permit the intermittent controlled movement of articles along the conveyor,
said cyclical raising and lowering of the load exhibiting compression forces upon the slip sheet in compression zones along the points of contact with conveyor braking surface, said compression forces creating deformations in the slip sheet akin to tracks or channels which aid in guidance, traction and control of the load while in transit to a destination; and
e) removing the load from the conveyor upon arrival to desired location.

2. The method as in claim 1 further comprising, optionally fixing the load to the slip sheet by a fastening means such as shrink wrap or straps.

3. The method in claim 1 further comprising, using a pallet above the slip sheet.

4. The method in claim 1 further comprising, reusing the slip sheet for repeated use.

5. The method in claim 1 further comprising, recycling the slip sheet after use.

6. The method in claim 1 further comprising, disposing of the slip sheet after use.
